(19) United States
(12) Patent Application Publication
(10) Pub. No.: US 2011/0206979 A1
(43) Pub. Date: Aug. 25, 2011

(54) LITHIUM-ION RECHARGEABLE ACCUMULATORS INCLUDING AN IONIC LIQUID ELECTROLYTE

(75) Inventors: Nelly Giroud, Grenoble (FR); Hélène Rouault, Le Versoud (FR)

(73) Assignees: Commissariat a l'energie atomique et aux energies alternatives, Paris (FR); CENTRE NATIONAL DE LA RECHERCHE SCIENTIFIQUE, Paris (FR)

(21) Appl. No.: 13/061,113

(22) PCT Filed: Aug. 24, 2009
(86) PCT No.: PCT/EP09/60884

§ 371 Date: May 12, 2011

(30) Foreign Application Priority Data
Aug. 29, 2008 (FR) 0855805

(51) Int. Cl. H01M 10/056; H01M 4/136; H01M 4/133; H01M 10/26; H01M 10/0585

(52) U.S. Cl. 429/162; 429/221; 429/336; 429/207

(57) ABSTRACT

The invention relates to a lithium ion rechargeable accumulator or secondary battery comprising a negative electrode, the active material of which is graphite carbon, a positive electrode, the active material of which is LiFePO₄, and an ionic liquid electrolyte comprising at least one ionic liquid of formula C⁺A⁻ wherein C⁺ represents a cation and A⁻ represents an anion, and at least one conducting salt, the ionic liquid electrolyte further comprising an organic additive which is vinyl ethylene carbonate (VEC).

### TECHNICAL FIELD

The invention relates to a lithium ion rechargeable accumulator (or secondary battery) comprising a liquid electrolyte.

More particularly, the invention relates to a lithium ion accumulator, battery, comprising a negative electrode in (made of) graphite carbon and a positive electrode in (made of) LiFePO₄ (lithiated iron phosphate) comprising a liquid electrolyte, more specifically an electrolyte comprising an ionic liquid solvent and a conducting salt.

The liquid electrolyte of the accumulator according to the invention may thus be called an ionic liquid electrolyte.

The invention more particularly relates to a lithium ion rechargeable accumulator (or secondary battery), the liquid electrolyte of which comprises an ionic liquid solvent and a lithium salt.

The invention finds its application in the field of electrochemical storage, in particular in the field of lithium ion accumulators or batteries.

### STATE OF THE PRIOR ART

Generally, the technical field of the invention may be defined as that of lithium accumulators, batteries, more particularly as that of the formulation of electrolytes, and still more specifically as that of the formulation of ionic liquid electrolytes, i.e. solutions comprising an ionic liquid solvent and a solute such as a conducting salt, where ionic conduction mechanisms come into play.

If the interest is more particularly on lithium accumulators or batteries, a lithium accumulator or battery is generally composed of:
two electrodes, i.e. a positive electrode and a negative electrode. The positive electrode generally comprises, as an electrochemically active material, lithium intercalation materials such as lamellar oxides of lithiated transition metals, olivines or lithiated iron phosphates (LiFePO₄) or spinels (for example the spinel LiNi_{0.5}Mn_{1.5}O₄). The negative electrode generally comprises as an electrochemically active material, metal lithium in the case of primary accumulators, batteries, or intercalation materials such as graphite carbon (C_{gr}) or lithiated titanium oxide (Li₄Ti₅O₁₂) in the case of accumulators, batteries, based on lithium-ion technology;
current collectors, generally in (made of) copper for the negative electrode, or in (made of) aluminium for the positive electrode which allows circulation of electrons, and therefore electron conduction, in the outer circuit;
an electrolyte where ion conduction occurs which ensures the passing of the lithium ions from one electrode to the other;
a separator with which it is possible to prevent contact between the electrodes and therefore short circuits. These separators may be microporous polymer membranes.

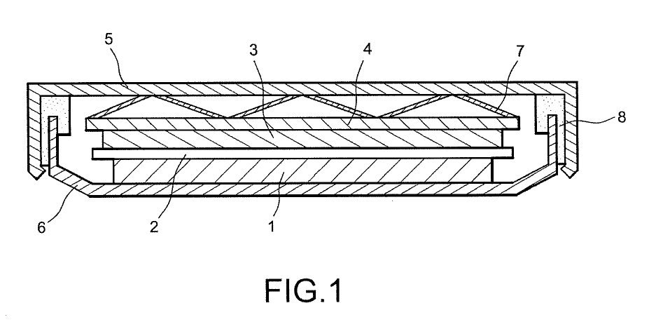

The accumulator or battery may notably have the shape of a button battery cell as described in FIG. 1.

The electrolytes used in present lithium or lithium ion accumulators or batteries are liquid electrolytes consisting of a mixture of organic solvents, most often carbonates, in which a lithium salt is dissolved.

The most current organic solvents are thus cyclic or linear carbonates, such as ethylene carbonate (EC), propylene carbonate (PC), dimethyl carbonate (DMC), diethyl carbonate (DEC), and vinylene carbonate (VC). Although they provide very good yield, these organic electrolytes pose safety problems. Indeed, they are flammable and volatile, which may generate fires and explosions in certain cases. Further, these electrolytes cannot be used at temperatures above 60° C. since, because of their volatility, they may cause swelling of the lithium accumulator and lead to an explosion of the latter.

The lithium salts added to the electrolytes are most often selected from the following salts:
LiPF₆: lithium hexafluorophosphate,
LiBF₄: lithium tetrafluoroborate,
LiAsF₆, lithium hexafluoroarsenate,
LiClO₄: lithium perchlorate,
LiBOB: lithium bis-oxalatoborate,
LiTFSI: lithium bis-(trifluoromethyl-sulfonyl)imide,
LiBeti: lithium bis(perfluoroethyl-sulfonyl)imide,
LiFSI: lithium bis(fluorosulfonyl)imidide,
or the salts of general formula Li[N(SO₂CₙF₂ₙ₊₁)(SO₂CₘF₂ₘ₊₁)], wherein n and m, either identical or different, are natural integers comprised between 1 and 10, preferentially between 1 and 5.

In order to overcome the safety and notably flammability and gas accumulation problems due to the low thermal stability, to the high vapor pressure and to the low flash point of the organic solvents of these liquid electrolytes, replacing them with ionic liquids was suggested.

Ionic liquids may be defined as liquid salts comprising a cation and an anion. The ionic liquids thus generally consist of a bulky organic cation, giving them a positive charge, with which is associated an inorganic anion which gives them a negative charge. Further, ionic liquids are, as indicated by their name, generally liquid in the temperature range from 0° C. to 200° C., notably around room temperature, and they are thus often designated as <<RTILs>> (Room Temperature Ionic Liquids).

The diversity of ionic liquids is such that it is possible to develop a large number of electrolytes. However there exists more interesting families of ionic liquids. These families are classified according to the type of cation used. Mention may notably be made of the following cations:
di- or tri-substituted imidazolium,
quaternary ammonium,
dialkyl piperidinium,
dialkyl pyrrolidinium,
dialkyl pyrazolium,
alkyl pyridinium,
tetra-alkyl phosphonium,
trialkyl sulfonium cations.

The most often associated anions are anions having a delocalized charge, such as BF₄⁻, B(CN)₄⁻, CH₃BF₃⁻, CH₂CHBF₃⁻, CF₃BF₃⁻, CₙF₂ₙ₊₁BF₃⁻, PF₆⁻CF₃CO₂⁻, CF₃SO₃⁻, N(SO₂CF₃)₂⁻, N(COCF₃)(SOCF₃)⁻, N(CN)₂⁻, C(CN)₃⁻, SCN⁻, SeCN⁻, CuCl₂⁻, AlCl₄⁻ etc.

The ionic liquid electrolyte then consists of an ionic liquid playing the role of a solvent and of a conducting salt such as a lithium salt.

Ionic liquid electrolytes are interesting from the point of view of safety in all kinds of electrochemical applications, since they exhibit great thermal stability—which may range for example up to 450° C. for mixtures of 1-butyl-3-methylimidazolium tetrafluoroborate BMIBF₄, and LiBF₄—, they have a wide liquid phase range, they are not flammable, and they have very low vapor pressure.

However, complex phenomena which are at the origin of a certain number of problems and drawbacks occur within the electrolytes comprising a mixture of ionic liquids and of conducting salts such as lithium salts.

Thus, when the lithium salt concentration increases, this is accompanied by lowering of the ionic conductivity and an increase in the viscosity. Further, the diffusion coefficients of lithium in these mixtures decrease for increasing lithium salt content. In fact, structuration of the mixture occurs which reduces the mobility of lithium ions.

Further, it is presently impossible to use an ionic liquid electrolyte with a negative electrode in (made of) graphite carbon since ionic liquid electrolytes are not very stable at low potentials. There is a reaction with the electrode at low potentials, which may alter the performances. In fact, a passivation layer has to be made, which protects the graphite electrode, so that it may be used. In other words, either the ionic liquid is not stable at the potential of the negative electrode in (made of) graphite carbon (0.1 to 0.3 Vs Li/Li⁺), or the passivation layer (or solid electrolyte interphase) is not of good quality, thereby preventing the accumulator from operating properly. The result of this is that the performances of the accumulator, in terms of restored capacity, are very low and its lifetime is very short.

Commercial electrolytes used with a graphite electrode are therefore conventional organic electrolytes such as those already mentioned above, consisting of a (binary or ternary) mixture of organic solvents in which a lithium salt is dissolved at a concentration of 1 mol/L. The most common organic solvents are cyclic or linear carbonates as already mentioned above.

In the case of an electrode in (made of) graphite carbon, the electrolyte that is typically used has the following composition: EC/PC/DMC 1:1:3 by mass plus 2% by mass VC with 1 mol/L LiPF₆. The VC has the purpose of generating a homogeneous passivation layer stabilizing the graphite electrode and the accumulator may thereby restore a good capacity.

However, all the problems posed by organic electrolytes which have already been mentioned in the foregoing, are then found again.

It is notably known that from 50° C., organic electrolytes are not stable. Indeed they begin to degrade and lose conductivity and the performances of the battery are reduced during successive charging-discharging cycles. Further, they are volatile and therefore flammable at high temperatures (above 60° C.), and they may generate fires and explosions. Organic electrolytes therefore limit the range of the temperature of use of the accumulators such as lithium ion accumulators and notably lithium ion accumulators with a negative electrode in (made of) graphite carbon.

In order to allow the use of an electrolyte based on an ionic solvent in a lithium ion accumulator, with a graphite electrode, document [1] proposes a liquid ionic electrolyte based on 3-methylimidazolium bis(trifluoromethylsulfonyl)imidide (EMI-TFSI) comprising small amounts of vinylene carbonate as an additive. It is thus possible to obtain stable cycling of a graphite —LiCoO₂— accumulator with an EMI_TFSI_lM LiPF₆₋5% vinylene carbonate electrolyte. The electrolyte of this document however has certain drawbacks such as a quite significant irreversible loss of capacity at the first cycle, and a lowering of the performances after 30 cycles.

Document [2] relates to liquid ionic electrolytes comprising N,N-diethyl-N-methyl-N-(2-methoxyethyl) ammonium bis-(trifluoromethylsulfonyl) imidide(DEME-TFSI) as a liquid ionic solvent and LiTFSI as a conducting salt.

The addition to these electrolytes of vinylene carbonate (VC) or ethylene carbonate (EC) ensures the formation of a passivation layer on the graphite electrode and prevents decomposition of the electrolyte. A graphite/Li-DEME-TFS accumulator with 10% of VC/LiCoO₂ was tested and showed satisfactory performances.

However, the electrolyte of this document apparently undergoes thermal degradation in two steps. The first in the vicinity of 100° C., and then the second one at 300° C. The electrolyte of this document is therefore far from being satisfactory.

As a conclusion, the electrolytes of documents [1] and [2] are not compatible with negative graphite electrodes.

Document [3] describes the addition to ionic liquid electrolytes for lithium ion accumulators, batteries, of organic additives allowing modification of the viscosity and increase in the ionic conductivity.

Examples of these organic compounds are organic carbonates. As examples of these organic carbonates, mention is made of alkyl carbonates, such as dialkyl carbonates, alkenyl carbonates, cyclic and non-cyclic carbonates, fluorinated organic carbonates such as fluoroalkyl carbonates, and the other halogenated organic carbonates.

The following compounds are more specifically mentioned: ethylene carbonate, propylene carbonate, butylene carbonate, methyl ethyl carbonate (EMC), diethyl carbonate (DEC), dimethyl carbonate (DMC), dipropyl carbonate (DPC), dibutyl carbonate (DBC), ethyl carbonate(EC), methyl and propyl carbonate (MPC), ethyl propyl carbonate (EPC).

In the examples of this document, an electrolyte comprising 60% by moles of EMI-TFSI and 40% by moles of EMC or 40% by moles of EMI-TFSI and 60% by moles of EMC, and 1.25 M of the lithium salt Li-TFSI is used with LiCoO₂ as an active cathode material and Li₄Ti₅O₁₂ as an active anode material.

In the electrolytes mentioned in the examples of this document, the carbonate cannot be described as an additive but rather as a significant component of a mixture, in an amount of 40%, or even 60% by moles. Therefore, there is a risk of having thermal degradation problems.

With view to the foregoing, there exists therefore a need for a lithium ion accumulator, battery, comprising an ionic liquid electrolyte, i.e. an electrolyte comprising an ionic liquid playing the role of a solvent and a conducting salt such as a lithium salt, in which the electrochemical reaction and its yield are not negatively affected notably because of the electrolyte.

In particular there exists a need for a lithium ion accumulator, battery, comprising an ionic liquid electrolyte, and more particularly for a lithium ion accumulator, battery, with a negative electrode in (made of) graphite carbon, with which excellent performances may be obtained notably as regards the restored, recovered capacity, and lifetime.

In other words, there exists a need for a lithium ion accumulator, battery, with an ionic liquid electrolyte, which, while having all the advantages of ionic liquid electrolytes notably in terms of safety of use, of thermal stability, and of non-flammable nature, does not have the drawbacks as regards insufficient performances of the accumulator, and ensures proper operation of the latter.

As already indicated above, there finally exists a need for an accumulator, battery, comprising an ionic liquid electrolyte which is compatible with negative electrodes in (made of) graphite carbon, which is not the case of any of the presently commercially available ionic liquid electrolytes.

### DISCUSSION OF THE INVENTION

The goal of the present invention is to provide a lithium ion rechargeable accumulator (or secondary battery) comprising an ionic liquid electrolyte which i.a. meets the needs listed above.

The goal of the present invention is further to provide a lithium ion rechargeable accumulator (or secondary battery) comprising a liquid electrolyte which does not have the drawbacks, defects, limitations and disadvantages of lithium ion rechargeable accumulators (or secondary batteries) comprising liquid electrolytes of the prior art, and which solves the problems of the prior art.

This goal and further other goals are achieved, according to the invention, with a lithium ion rechargeable accumulator (or secondary battery) comprising a negative electrode, the active material of which is graphite carbon, a positive electrode, the active material of which is LiFePO₄, and an ionic liquid electrolyte comprising at least one ionic liquid of formula C⁺A⁻ wherein C⁺ represents a cation and A⁻ represents an anion, and at last one conducting salt, the ionic liquid electrolyte further comprising an organic additive which is vinyl ethylene carbonate (VEC).

A lithium ion rechargeable accumulator, battery, comprising a negative electrode, the active material of which is graphite carbon, a positive electrode, the active material of which is LiFePO₄, and the ionic liquid electrolyte as defined above have never been described in the prior art.

The lithium ion accumulator, battery, according to the invention results from the selection of a specific active material for a negative electrode, from the selection of a specific active material for a positive electrode, and finally from the selection of a specific ionic electrolyte. The combination of these three specific elements in a lithium ion accumulator, battery, is neither described or suggested in the prior art and unexpectedly leads to a lithium ion accumulator, battery, having improved properties.

In particular, the ionic liquid electrolyte of the accumulator according to the invention is fundamentally distinguished from ionic liquid electrolytes of the prior art in that it comprises a specific organic additive which is vinyl ethylene carbonate (VEC).

Vinyl ethylene carbonate has never been added to ionic liquids.

In documents [1] to [3] mentioned above, vinyl ethylene carbonate is never mentioned among the organic additives which are added to ionic liquids.

Document [4] describes the addition of VEC to propylene carbonate, i.e. to a conventional organic solvent, in an electrolyte for a lithium ion accumulator, battery, with a graphite electrode. The addition of an additive to an ionic liquid can by no means be inferred from the addition of the same additive to conventional solvents because of the specificity of ionic liquids, and the electrolyte of this document has all the drawbacks of conventional organic electrolytes.

In the accumulator, battery, according to the invention, the electrochemical reaction and its yield are not affected by the specific ionic liquid electrolyte being used.

By using the specific ionic liquid electrolyte described above in a lithium ion accumulator, the active material of which for the negative electrode is specifically graphite carbon, and the active material of which for the positive electrode is specifically LiFePO₄, excellent performances may be obtained especially as regards restored, recovered capacity and lifetime.

The ionic liquid electrolyte used in the accumulator, battery, according to the invention, while having all the advantages of ionic liquid electrolytes notably in terms of safety of use, of thermal stability, and of non-flammable nature does not have the drawbacks thereof as regards the insufficient performances of the accumulator, battery, and ensures proper operation of the latter. Surprisingly, it was shown that in the accumulator according to the invention, the addition to an ionic liquid electrolyte comprising an ionic liquid of the specific additive VEC did not by any means alter the stability, notably thermal stability, of this ionic liquid, which remained unchanged and very high. For example, the electrolyte of the accumulator, battery, according to the invention has a much better thermal stability than that of the electrolyte of document [2].

In the accumulator, battery, according to the invention, surprisingly, the specific ionic liquid electrolyte that is used is compatible with the negative electrodes in (made of) graphite carbon that are specifically used; that is not the case of any of the presently commercially available ionic liquid electrolytes.

In particular, with the added specific additive it is possible to obtain a passivation layer of excellent quality on a negative graphite electrode, even though this passivation layer does not exist or is of less good quality without this additive.

The electrochemical performances of an accumulator, battery, according to the invention, using the specific electrolytes mentioned above are improved, notably in terms of practical capacity when they are compared with performances of an accumulator, battery, using an analogous electrolyte but without this additive.

Also, it has been found that the performances of the accumulator, battery, according to the invention, using the specific electrolyte described above are improved, in particular in terms of practical capacity when they are compared with the performances of an accumulator, battery, using an analogous electrolyte but with the VC additive. The tests carried out with the latter actually did not prove to be satisfactory.

Also, the performances of an accumulator, battery according to the invention using the specific electrolyte described above are improved, in particular in terms of practical capacity when they are compared with the performances of an accumulator, battery, using a conventional organic electrolyte such as an EC/PC/DMC (mass proportions 1/1/3) electrolyte with 1 mole/L of LiPF₆.

Advantageously, the cation C⁺ of the ionic liquid is selected from organic cations.

Thus, the cation C⁺ of the ionic liquid may be selected from hydroxonium, oxonium, ammonium, amidinium, phosphonium, uronium, thiouronium, guanidinium, sulfonium, phospholium, phosphorolium, iodonium, carbonium cations; heterocyclic cations such as pyridinium, quinolinium, isoquinolinium, imidazolium, pyrazolium, imidazolinium, triazolium, pyridazinium, pyrimidinium, pyrrolidinium, thiazolium, oxazolium, pyrazinium, piperazinium, piperidinium, pyrrolium, pyrizinium, indolium, quinoxalinium, thiomorpholinium, morpholinium, and indolinium cations; and the tautomeric forms of the latter.

Advantageously, the cations C⁺ of the ionic liquid is selected from non-substituted or substituted imidazoliums such as di-, tri-, tetra- and penta-alkyl imidazoliums, quaternary ammoniums, non-substituted or substituted piperidiniums such as dialkylpiperidiniums, non-substituted or substituted pyrrolidiniums such as dialkylpyrrolidiniums, non-substituted or substituted pyrazoliums such as dialkylpyrazoliums, non-substituted or substituted pyridiniums such as alkylpyridiniums, phosphoniums such as tetraalkylphosphoniums, sulfoniums such as trialkylsulfoniums, and the tautomeric forms of the latter.

Preferably the cation C⁺ of the ionic liquid is selected from piperidiniums such as dialkylpiperidiniums; quaternary ammoniums such as the quaternary ammoniums bearing four alkyl groups; imidazoliums such as di-, tri-, tetra-, and penta-substituted imidazoliums such as di-, tri-, tetra-et penta-alkyl imidazoliums; and the tautomeric forms of the latter.

Preferably, the cation C⁺ of the ionic liquid is selected from N,N-propyl-methylpiperidinium, 1-hexyl-3-methylimidazolium, 1-n-butyl-3-methyl-imidazolium and 1,2-dimethyl-3-n-butylimidazolium.

The anion A⁻ of the ionic liquid may be selected from halides such as Cl⁻, BF₄⁻, B(CN)₄⁻, CH₃BF₃⁻, CH₂CHBF₃⁻, CF₃BF₃⁻, m-CₙF₂ₙ₊₁BF₃⁻ wherein n is an integer such that 1≦n≦10, PF₆⁻, CF₃CO₂⁻, CF₃SO₃⁻ N(SO₂CF₃)₂⁻, N(COCF₃)(SOCF₃)⁻, N(CN)₂⁻, C(CN)₃⁻, SCN⁻, SeCN⁻, CuCl₂⁻, and AlCl₄⁻.

The anion A⁻ of the ionic liquid is preferably selected from BF₄⁻ et TFSI-(N(SO₂CF₃)₂⁻), TFSI being further preferred.

A preferred ionic liquid comprises a cation C⁺ selected from piperidiniums, quaternary ammoniums and imidazoliums, associated with an anion selected from BF₄⁻ and TFSI-(N(SO₂CF₃)₂).

Advantageously, the ionic liquid is selected from PP₁₃TFSI, or N,N-propyl-methylpiperidinium bis(trifluoromethanesulfonyl)imidide; HMITFSI or (1-hexyl-3-methylimidazolium)bis(trifluoromethane-sulfonyl)imidide; DMBIFSI or (1,2-dimethyl-3-n-butyl-imidazolium)bis(trifluoromethanesulfonyl)imidide; BMITFSI or (1-n-butyl-3-methylimidazolium) bis-(trifluoro-methanesulfonyl)imidide; and mixtures thereof.

Advantageously, the conducting salt is selected from lithium salts.

Thus, the conducting salt may be selected from LiPF₆: lithium hexafluorophosphate, LiBF₄: lithium tetrafluoroborate, LiAsF₆, lithium hexafluoroarsenate, LiClO₄: lithium perchlorate, LiBOB: lithium bis oxalatoborate, LiFSI: lithium bis(fluorosulfonyl) imidide, salts of general formula Li [N(SO₂CₙF₂ₙ₊₁) (SO₂CₘF₂ₘ₊₁)]) wherein n and m, either identical or different, are natural integers comprised between 1 and 10, such as LiTFSI: lithium bis(trifluoromethyl-sulfonyl)imidide or LiN(CF₃SO₂)₂, or LiBeti: lithium bis(perfluoroethylsulfonyl)imidide, LiODBF, LiB(C₆H₅), LiCF₃SO₃, LiC(CF₃SO₂)₃ (LiTFSM), and mixtures thereof.

Preferably, the conducting salt is selected from LiTFSI, LiPF₆, LiFSI, LiBF₄, and mixtures thereof.

The electrolyte may generally comprise from 0.1 to 10 mol/L of conducting salt.

The electrolyte generally comprises from 1 to 10%, preferably from 2 to 5% by volume of VEC additive based on the volume of the ionic liquid.

Advantageously, the electrolyte may only be composed of the ionic electrolyte(s), the conducting salt(s) and the organic additive.

A preferred electrolyte for the accumulator according to the invention comprises LiTFSI in an ionic liquid solvent selected from PP₁₃TFSI, HMITFSI, DMBITFSI and BMITFSI; and from 1 to 10% by volume, preferably 5% by volume of VEC.

Advantageously, this preferred electrolyte comprises 1.6 mol/L of LiTFSI.

More specifically, a first more preferred electrolyte of the accumulator according to the invention comprises LiTFSI in the ionic liquid solvent PP₁₃TFSI; and from 1 to 10% by volume, preferably 5% by volume of VEC.

A second more preferred electrolyte of the accumulator according to the invention comprises LiTFSI in the ionic liquid solvent HMITFSI; and from 1 to 10% by volume, preferably 5% by volume of VEC.

A third more preferred electrolyte of the accumulator according to the invention comprises LiTFSI in the ionic liquid solvent BMITFSI; and from 1 to 10% by volume, preferably 5% by volume of VEC.

A fourth more preferred electrolyte of the accumulator according to the invention comprises LiTFSI in the liquid ionic solvent DMBITFSI; and from 1 to 10% by volume, preferably 5% by volume of VEC.

Advantageously, each of these four more preferred electrolytes comprises 1.6 mol/L of LiTFSI.

The application, use, of the electrolyte described above is particularly advantageous with a negative electrode, the active material of which is graphite carbon with which it is totally compatible and ensures excellent performances.

The application, use, of this electrolyte is even more advantageous, if additionally, the positive electrode comprises LiFePO₄ as an active material.

The accumulator, battery, according to the invention may be a button battery cell.

The invention therefore further relates to a liquid electrolyte comprising LiTFSI, preferably in an amount of 1.6 mol/L, in an ionic liquid solvent, selected from PP₁₃TFSI, HMITFSI, DMBITFSI, and BMITFSI; and from 1 to 10% by volume, preferably 5% by volume of VEC.

The invention will now be described more specifically in the following description, given as an illustration and not as a limitation, with reference to the appended drawings wherein:

FIG. 1 is a schematic vertical sectional view of a accumulator, battery, in the form of a button battery cell comprising an electrolyte, for example an electrolyte to be tested, applied according to the invention such as the electrolyte prepared in Example 1 or in Example 2, or else a comparative electrolyte.

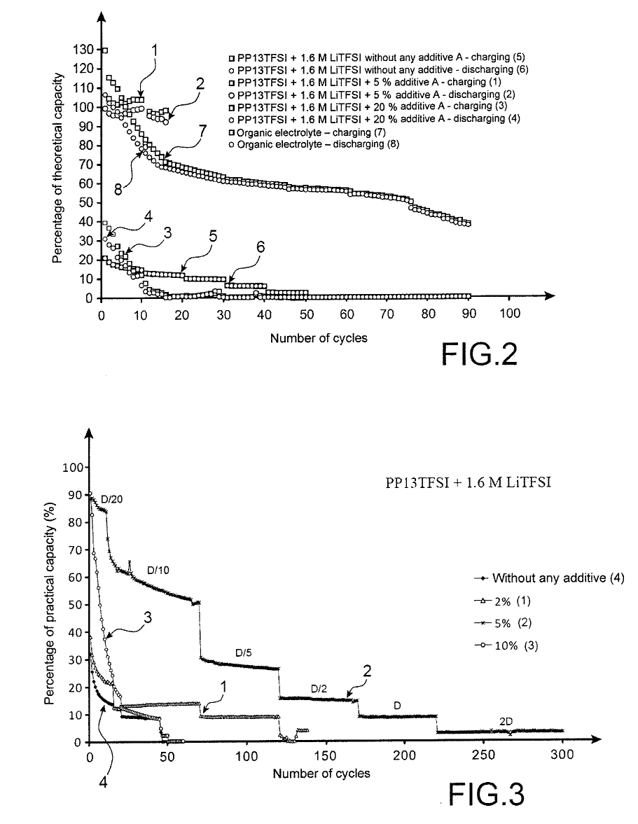

FIG. 2 is a graph which compares the performances during cycling for an electrolyte applied, used, according to the invention PP₁₃TFSI+1.6 M LiTFSI with respectively 5% of VEC additive (curve 1: charging; curve 2: discharging), 20% of VEC additive (curve 3: charging; curve 4: discharging); for a comparative electrolyte PP₁₃TFSI+1.6 M LiTFSI without any organic additive (curve 5: charging; curve 6: discharging); and for an organic electrolyte “ORG” (curve 7: charging; curve 8: discharging). The number of cycles is plotted in abscissas, and the percentage of theoretical capacity is plotted in ordinates.

FIG. 3 is a graph which compares the performances during cycling for an electrolyte applied, used, according to the invention PP₁₃TFSI+1.6 M LiTFSI with respectively 2% of VEC additive (curve 1), 5% of VEC additive (curve 2), and 10% of VEC additive (curve 3), and for a comparative electrolyte PP₁₃TFSI+1.6 M LiTFSI without any organic additive (curve 4). The number of cycles is plotted in abscissas and the percentage of practical capacity is plotted in ordinates.

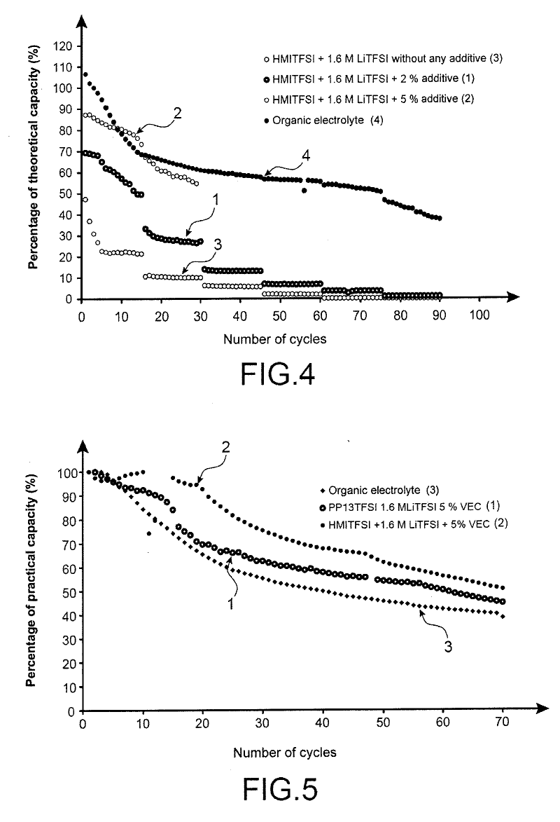

FIG. 4 is a graph which compares the performances during cycling for an electrolyte applied, used, according to the invention HMITFSI+1.6 M LiTFSI with respectively 2% of VEC additive (curve 1), and 5% of VEC additive (curve 2); for a comparative electrolyte HMITFSI+1.6 M LiTFSI without any organic additive (curve 3); and for an organic electrolyte “ORG” (curve 4). The number of cycles is plotted in abscissas and the percentage of practical capacity is plotted in ordinates.

FIG. 5 is a graph which compares the performances during cycling for an electrolyte applied, used, according to the invention PP₁₃TFSI+1.6 M LiTFSI with 5% of VEC additive (curve 1); for an electrolyte applied, used, according to the invention HMITFSI+1.6 M LiTFSI with 5% of VEC additive (curve 2); and for an organic electrolyte “ORG” (curve 3). The number of cycles is plotted in abscissas and the percentage of practical capacity is plotted in ordinates.

This description generally more particularly refers to an embodiment which relates to a lithium ion accumulator, battery, according to the invention in which the negative electrode is an electrode, the active material of which is graphite carbon, and the positive electrode is an electrode, the active material of which is LiFePO₄, and the liquid electrolyte is the specific liquid electrolyte described above.

The application of this specific electrolyte proved to be particularly advantageous in this type of accumulator, battery, according to the invention.

The specific ionic liquid electrolyte of the accumulator according to the invention comprises at least one ionic liquid, playing the role of a solvent, of formula C⁺A⁻ wherein C⁺ represents a cation and A⁻ represents an anion, at least one conducting salt, and further at least one additive which is vinyl ethylene carbonate.

By at least one ionic liquid is meant that the electrolyte of the accumulator according to the invention may comprise one single ionic liquid or it may comprise several of these ionic liquids which may for example differ by the nature of the cation and/or of the anion which make them up.

Also, by at least one conducting salt is meant that the electrolyte of the accumulator according to the invention may comprise one single conducting salt or several conducting salts.

The ionic liquid of the electrolyte of the accumulator, battery, according to the invention plays the role of a solvent for the conducting salt. By <<liquid>> is generally meant that the ionic liquid solvent is liquid in a range of temperatures from 0 to 200° C., and that it is notably liquid in the vicinity of room temperature i.e. from 15 to 30° C., preferably from 20 to 25° C.

The ionic liquid of the ionic electrolyte of the accumulator, battery, according to the invention is generally thermally stable up to a temperature which may for example reach 450° C.

It was surprisingly noticed that the ionic liquid electrolyte of the accumulator, battery, according to the invention was further thermally stable up to much high temperatures, which means that the addition of the organic additive does not alter the thermal stability of the ionic liquid electrolyte which globally has a thermal stability comparable with that, which is high, of the ionic solvent.

For example, while VEC alone is degraded at 230° C., thermogravimetric analyses conducted on the ionic liquid electrolyte with the specific additive VEC according to the invention have shown that this electrolyte was stable up to 450° C.

There is no limitation as to the selection for the C′ cation of the ionic liquid.

Preferably, the C′ cation is selected from organic cations, notably <<bulky>> organic cations, i.e. cations including groups known to the man skilled in the art of organic chemistry as having significant steric hindrance.

Thus, the C⁺ cation of the ionic liquid may be selected from the hydroxonium, oxonium, ammonium, amidinium, phosphonium, uronium, thiouronium, guanidinium, sulfonium, phospholium, phosphorolium, iodonium, carbonium cations; heterocyclic cations, and the tautomeric forms of these cations.

By heterocyclic cations are meant cations from heterocycles i.e. cycles comprising one or more hetero-atom(s) generally selected from N, O, P, and S.

These heterocycles may be saturated, unsaturated or aromatic, and they may further be condensed with one or more other heterocycle(s) and/or one or more other saturated, unsaturated or aromatic carbonaceous cycle(s).

In other words these heterocycles may be monocyclic or polycyclic.

These heterocycles may further be substituted with one or more substituent(s), either identical or different, preferably selected from linear or branched alkyl groups with 1 to 20 carbon atoms such as methyl, ethyl, n-propyl, i-propyl, n-butyl, i-butyl, and t-butyl groups; cycloalkyl groups with 3 to 7 C atoms; linear or branched alkenyl groups with 1 to 20 carbon atoms; linear or branched alkynyl groups with 1 to 20 carbon atoms; aryl groups with 6 to 10 carbon atoms such as the phenyl group; (C₁-C₂₀ alkyl)-(C₆-C₁₀ aryl) groups such as the benzyl group.

The heterocyclic cations may be selected from pyridinium, quinolinium, isoquinolinium, imidazolium, pyrazolium, imidazolinium, triazolium, pyridazinium, pyrimidinium, pyrrolidinium, thiazolium, oxazolium, pyrazinium, piperazinium, piperidinium, pyrrolium, pyrizinium, indolium, quinoxalinium, thiomorpholinium, morpholinium, and indolinium cations.

These cations may optionally be substituted as defined above.

The heterocyclic cations also include the tautomeric forms of the latter.

Examples of heterocyclic cations which may form the C⁺ cation of the ionic liquid solvent of the electrolyte of the accumulator according to the invention are given below:

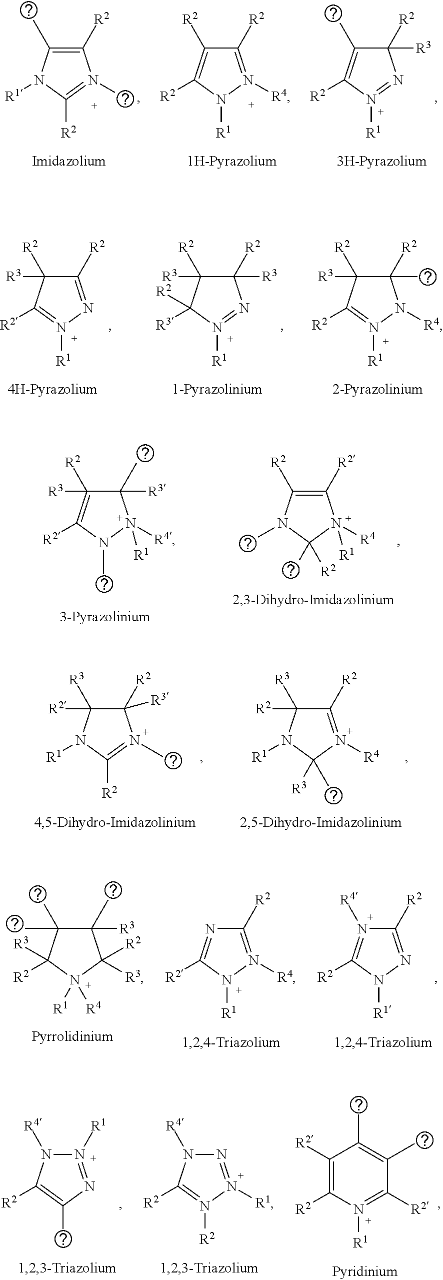

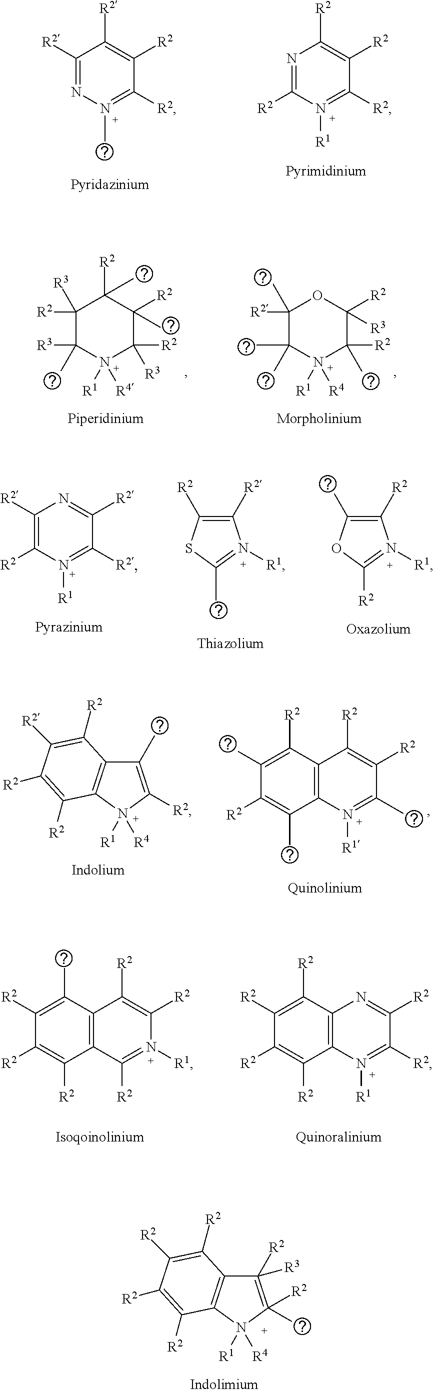

In these formulae, the groups R¹, R², R³ and R⁴, independently of each other represent a hydrogen atom or a substituent preferably selected from the groups already listed above, notably linear or branched alkyl groups with 1 to 20 C atoms.

The variety of ionic liquids is such that it is possible to prepare a large number of electrolytes. However, families of ionic liquids are more interesting, notably for the applications which are more particularly targeted herein. These families of ionic liquids are defined by the type of applied, used, C⁺ cation.

Thus, preferably, the C⁺ cation of the ionic liquid of the electrolyte according to the invention will be selected from non-substituted or substituted imidazoliums such as di-, tri-, tetra- and penta-alkyl imidazoliums, quaternary ammoniums, non-substituted or substituted piperidiniums such as dialkylpiperidiniums, non-substituted or substituted pyrrolidiniums such as dialkylpyrrolidiniums, non-substituted or substituted pyrazoliums, dialkylpyrazoliums, non-substituted or substituted pyridiniums such as alkylpyridiniums, phosphoniums, tetra-alkylphosphoniums, and sulfoniums such as trialkylsulfoniums.

Preferably the C⁺ cation of the ionic liquid is selected from piperidiniums such as dialkylpiperidiniums, quaternary ammoniums such as quaternary ammoniums bearing four alkyl groups, and imidazoliums such as di, tri-, tetra-, and penta-substituted imidazoliums such as di-, tri-, tetra- and penta-alkyl imidazoliums.

As this was already specified above, the alkyl groups have 1 to 20 C atoms and may be linear or branched.

Herein, when a substitution with several alkyl groups is mentioned (<<dialkyl>>, <<trialkyl>> etc. . . . ), these alkyl groups may be identical or different.

Among these cations, dialkylpiperidiniums, quaternary ammoniums bearing four alkyl groups and di-, tri-, tetra- and penta-alkyl imidazoliums are specially preferred. However as regards imidazolium cations, di- and tri-substituted imidazoliums have better physico-chemical and electrochemical properties and are therefore still more preferred.

These preferred cations were selected since the imidazolium cation has the greatest ion conductivities as well as the lowest viscosity. The piperidinium cation exhibits very high electrochemical stability and average levels of ionic conductivity and of viscosity. Finally, the quaternary ammoniums are very stable electrochemically but have very low ion conductivities.

The cations preferred among all of them are selected from N,N-propyl-methylpiperidinium, 1-hexyl-3-methylimidazolium, 1-n-butyl-3-methylimidazolium and 1,2-dimethyl-3-n-butylimidazolium cations since it was found that with these three specific cations selected from a very large number of possible cations, excellent properties, and surprisingly improved performances were obtained. These cations notably have the advantage of being inert with regard to the positive electrode material LiFePO₄ of the accumulator according to the invention.

Also, there is no limitation as to the choice for the anion A⁻ of the ionic liquid.

Preferably, the A⁻ anion of the ionic liquid is selected from halides such as Cl⁻, BF₄⁻, B(CN)₄⁻, CH₃BF₃⁻, CH₂CHBF₃⁻, CF₃BF₃⁻, m-CₙF₂ₙ₊₁BF₃⁻ (wherein n is an integer such as 1≦n≦10, PF₆⁻, CF₃CO₂⁻, CF₃SO₃⁻, N(SO₂CF₃)₂⁻, N(COCF₃)(SOCF₃)⁻, N(CN)₂⁻, C(CN)₃⁻, SCN⁻, SeCN⁻, CuCl₂⁻, and AlCl₁₄⁻.

More preferred anions are the anions BF₄⁻ and TFSI-(N(SO₂CF₃)₂).

With these anions, it is actually possible to increase the ionic conductivity and to decrease the viscosity. Moreover, the anion TFSI⁻ is slightly more stable at a high potential. It is quite obvious that other anions may however be selected.

A more preferred ionic liquid for the ionic liquid electrolyte of the accumulator according to the invention comprises as an anion, a BF₄ or TFSI-(N(SO₂CF₃)₂⁻) anion and as a cation, a piperidinium, quaternary ammonium or imidazolium cation. The association of such an anion and of such a cation imparts extremely advantageous properties to the ionic liquid electrolyte.

Advantageously, the ionic liquid is selected from PP₁₃TFSI, or N,N-propyl-methylpiperidinium bis(trifluoromethanesulfonyl)imidide; HMITFSI or (1-hexyl-3-methylimidazolium)bis(trifluoromethane-sulfonyl)imidide; DMBIFSI or (1,2-dimethyl-3-n-butylimidazolium)bis(trifluoromethanesulfonyl)imidide; BMITFSI or (1-n-butyl-3-methyl-imidazolium) bis(trifluoro-methanesulfonyl)imidide and mixtures thereof.

PP₁₃TFSI fits the following formulae:

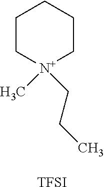

These ionic liquids which comprise the association of a specific cation and of a specific anion have surprisingly advantageous properties, and notably better stability of the cation during reduction.

There is no limitation as to the choice of the conducting salt of the ionic liquid electrolyte of the accumulator according to the invention.

The conducting salt is preferably a lithium salt which is particularly well suitable for the electrolyte of the rechargeable lithium ion accumulator (lithium ion secondary battery) according to the invention.

This lithium salt may be selected from LiPF₆: lithium hexafluorophosphate, LiBF₄: lithium tetrafluoroborate, LiAsF₆, lithium hexafluoroarsenate, LiClO₄: lithium perchlorate, LiBOB: lithium bis-oxalatoborate, LiFSI: lithium bis(fluorosulfonyl) imidide, salts of general formula Li[N(SO₂CₙF₂ₙ₊₁) (SO₂CₘF₂ₘ₊₁)] wherein n and m, either identical or different, are natural integers comprised between 1 and 10, such as LiTFSI: lithium bis(trifluoromethylsulfonyl imidide or LiN (CF₃SO₂)₂, or LiBeti: lithium bis(perfluoroethylsulfonyl)imidide, LiODBF, LiB(C₆H₅), LiCF₃SO₃, LiC(CF₃SO₂)₃ (LiTFSM), and mixtures thereof.

The lithium salts to be added into the ionic liquids are preferentially, in this order: LiTFSI, LiPF₆, LiFSI, LiBF₄.

Indeed, better ion conductivities are obtained for these salts, and further with LiTFSI, the viscosity is the lowest.

The total concentration of the conducting salt(s) in the ionic liquids may be comprised between 0.1 mol/L per liter of ionic liquid solvent up to their solubility limit in the selected ionic liquid solvent, preferably it is from 0.1 to 10 mol/L.

The specific organic additive may be considered as the essential, fundamental constituent of the electrolyte of the accumulator according to the invention since this is the constituent which differentiates the electrolyte of the accumulator according to the invention from the electrolytes of accumulators of the prior art and it is this additive which is at the origin of the surprising and advantageous properties of the electrolyte of the accumulator according to the invention notably in terms of recovered capacity.

This organic additive is vinyl ethylene or 4-vinyl-1,3-dioxolane-2-one which fits the following formula:

### Formula of VEC:

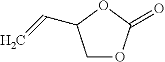

The electrolyte of the accumulator, battery, according to the invention generally comprises from 1 to 10%, preferably from 2 to 5% by volume of additive based on the volume of ionic liquid. Improvement of the performances is obtained in the aforementioned range from 1 to 10%, and this even with addition of a low percentage of additive, such as 1% by volume, however best performances are obtained in the narrow range from 2 to 5% by volume and the optimum percentage is 5% by volume for which best performances and improvements are obtained.

The electrolyte of the accumulator, battery, according to the invention may only contain the ionic liquid(s), the conducting salt(s) and the organic additive, in other words, the electrolyte may be composed of (may consist in) the ionic liquid(s), the conducting salt(s) and the organic additive.

A preferred electrolyte of the accumulator, battery, according to the invention comprises LiTFSI in an ionic liquid solvent selected from PP₁₃TFSI, HMITFSI, DMBITFSI, and BMITFSI; and from 1 to 10% by volume, preferably 5% by volume of VEC.

Advantageously, this preferred electrolyte comprises 1.6 mol/L of LiTFSI.

A first more preferred electrolyte of the accumulator, battery, according to the invention comprises LiTFSI, preferably 1.6 mol/L of LiTFSI, in the ionic liquid solvent PP₁₃TFSI; and from 1 to 10% by volume, preferably 5% by volume of VEC.

A second more preferred electrolyte of the accumulator, battery, according to the invention comprises LiTFSI, preferably 1.6 mol/L of LiTFSI, in the ionic liquid solvent HMITFSI; and from 1 to 10% by volume, preferably 5% by volume of VEC.

A third more preferred electrolyte of the accumulator, battery, according to the invention comprises LiTFSI, preferably 1.6 mol/L of LiTFSI, in the ionic liquid solvent DMBITFSI; and from 1 to 10% by volume, preferably 5% by volume of VEC.

A fourth more preferred electrolyte of the accumulator, battery, according to the invention comprises LiTFSI, preferably 1.6 mol/L of LiTFSI, in the ionic liquid solvent BMITFSI; and from 1 to 10% by volume, preferably 5% by volume of VEC.

Surprisingly it was found that the preferred electrolyte according to the invention comprising a particular ionic solvent, a particular conducting salt and a specific organic additive i.e. VEC, had a set of unexpected and remarkable properties, notably when it was applied, used, in the accumulator, battery, according to the invention.

Each of the four more preferred electrolytes similarly has unexpectedly a set of remarkable properties and still more markedly, notably when they are applied, used, in the accumulator, battery, according to the invention.

Nothing was able to predict that by selecting a particular ionic liquid solvent from all the existing ionic liquid solvents, a particular conducting salt such as LiTFSI among all the known conducting salts, by using specifically VEC as an organic additive, and further by optionally selecting specific proportions for each of these components, for example a VEC content from 1 to 10% by volume and an LiTFSI content of 1.6 mol/L, it would be possible to obtain such a combination of properties.

The preferred electrolyte and each of the four more preferred electrolytes at least result from a triple or even quadruple, quintuple or sextuple selection.

The preferred electrolyte and each of the four more preferred electrolytes have remarkable performances in lithium accumulators, batteries, notably as regards capacity and practical recovered capacity, these performances are better than, superior to, those of an organic electrolyte for example by 15 to 30%.

These performances are also surprisingly superior to, better than, those of the ionic liquid electrolyte without any additive.

The preferred electrolyte and the four more preferred electrolytes are stable up to very high temperatures for example up to 450° C., they are not flammable above 50° C. and they may operate without any problem at such temperatures, indeed all their constituents are compatible for an application, use, at these temperatures.

The rechargeable electrochemical lithium ion accumulator (electrochemical lithium ion secondary battery) comprises, in addition to the ionic liquid electrolyte as defined above, a negative electrode, the active material of which is graphite carbon, and a positive electrode, the active material of which is LiFePO₄.

The electrodes comprise a binder which generally is an organic polymer, an electrochemically active material of a positive or negative electrode, optionally one or more electron conducting additives, and a current collector.

In the positive electrode, the electrochemically active material may be selected from olivines, LiFePO₄.

In the negative electrode, the electrochemically active material may be selected from carbonaceous compounds such as natural or synthetic graphites and disordered carbons.

The optional electron conducting additive may be selected from metal particles such as Ag particles, graphite, carbon black, carbon fibers, carbon nanowires, carbon nanotubes and electron conducting polymers, and mixtures thereof.

It is found according to the invention that the specific ionic liquid electrolyte described above was particularly well suitable to an application, use, in a lithium ion accumulator, battery, in which the negative electrode is specifically an electrode, the active material of which is graphite carbon, and the positive electrode is specifically an electrode, the active material of which is LiFePO₄. Indeed, surprisingly, by adding a specific organic additive to an ionic liquid electrolyte, it is possible to use for the first time an ionic liquid electrolyte, essentially consisting of an ionic solvent with such a negative electrode in (made of) graphite carbon, while obtaining an accumulator, battery, with excellent performances and long lifetime. Previously, it was considered that it was impossible to use an ionic liquid electrolyte with a graphite carbon electrode, and in this respect, the invention goes against a considerably widespread prejudice in this technical field and overcomes this prejudice. These particularly surprising and advantageous effects related to the application, use, in the ionic liquid electrolyte of the accumulator, battery, according to the invention, of a specific additive, may be explained by the fact that the additive acts on the surface of the graphite electrode by depositing thereon a stable slightly resistive and homogeneous passivation layer.

The current collectors are generally in (made of) copper for the negative electrode, or in (made of) aluminium for the positive electrode.

The accumulator may notably have the form of a button battery cell.

The different components, elements, of a button battery cell in (made of) stainless steel 316L, are described in FIG. 1.

These components, elements, are the following:
the upper (5) and lower (6) portions of the stainless steel casing,
the polypropylene gasket (8),
the stainless steel shims, skids, (4),
   which are used both optionally for cutting out the lithium metal and then later on for ensuring good contact of the current collectors with the external portions of the cell,
a spring (7), which ensures the contact between all the components, elements,
a microporous separator (2),
electrodes (1) (3).

The invention will now be described with reference to the following examples, given as an illustration and not as a limitation.

### EXAMPLE 1

Electrolytes compliant with the one applied, used, according to the invention, comprising an ionic liquid, a lithium salt and an organic additive, are prepared.
The ionic liquid is PP₁₃TFSI, or N,N-propyl-methylpiperidinium bis(trifluoro-methane-sulfonyl)imidide;
the lithium salt is LiTFSI;
the organic additive is vinyl ethylene carbonate.

The electrolytes are formulated by dissolving 1.6 mol/l of LiPF₆ in the ionic liquid solvent, and then by respectively adding 2%, 5%, 10% and 20% by volume of organic additive: these are 2%, 5%, 10% or 20% based on the volume of ionic liquid added to the lithium salt powder.

### EXAMPLE 2

Electrolytes compliant with the one applied, used, according to the invention comprising an ionic liquid, a lithium salt and an organic additive, are prepared.
The ionic liquid is HMITFSI or 1-hexyl-3-methylimidazolium bis(trifluoromethanesulfonyl) imidide.
the lithium salt is LiTFSI, or lithium hexafluorophosphate.
the organic additive is vinyl ethylene carbonate (VEC).

The electrolyte is formulated by dissolving 1.6 mol/L of LiTFSI in the ionic liquid solvent and then by respectively adding 2 and 5% by mass of organic additive.

The electrolytes prepared above in Examples 1 and 2 were then tested in a button battery cell.

A first comparative electrolyte which is a conventional organic electrolyte “ORG” which contains EC(ethylene carbonate), PC(propylene carbonate), DMC (dimethyl carbonate) in mass proportions of 1/1/3 respectively, was also tested in a cell with the button cell format. In these solvents, 1 mol/L of LiPF₆ is then added and, to the whole formed by the organic solvents and the lithium salt, 20 by mass of VC are added.

A second and third comparative electrolytes which are electrolytes which are identical with those of Examples 1 and 2 but without any additives, were also tested in the same way in a button battery cell. These are the electrolytes PP₁₃TFSI+1.6 M LiTFSI or HMITFSI+1.6 M LiTFSI.

Each button cell is mounted by scrupulously observing the same procedure. The following are thereby stacked from the bottom of the casing of the cell as this is shown in FIG. 1:
a negative electrode (1) Ø 14 mm, for these tests, this is an electrode, the active material of which is graphite carbon into which lithium is inserted during the operation of the accumulator, battery, the electrode is further composed of a polymeric binder and of electronic conductors;
200 μL of electrolyte as prepared in Example 1 or in Example 2;
a separator which is a microporous polyolefin membrane, more specifically a microporous membrane in (made of) polypropylene Celgard® (2) Ø 16.5mm;
a positive electrode, the active material of which is LiFePO4;
a stainless disc or shim, skid, (4),
a stainless steel lid (5) and a stainless steel bottom (6);
a stainless steel spring (7) and a polypropylene gasket, joint, (8).

The stainless steel casing is then closed with a crimping machine, making it perfectly airproof. In order to check whether the cells are operational, the latter are checked by measuring the floating voltage.

Because of the high reactivity of lithium and of its salts to oxygen and water, the setting up of a button battery cell is carried out in a glove box. The latter is maintained with a slight positive pressure under an atmosphere of anhydrous argon. Sensors allow continuous monitoring of the oxygen and water concentrations. Typically, these concentrations should remain less than 1 ppm.

The electrolytes prepared in Examples 1 and mounted in button battery cells which are button cells according to the invention and the comparative electrolytes mounted in button battery cells which are not compliant with the invention, according to the procedure described above are subject to cycling operations, i.e. charging and discharging cycles under different conditions of constant current for a determined number of cycles, in order to evaluate the practical capacity of the cell.

For example, a battery which is charged under C/20 conditions is a battery to which a constant current is imposed for 20 hours with the purpose of recovering the whole of its capacity C. The value of the current is equal to the capacity C divided by the number of charging hours, i.e. in this case 20 hours.

A first test procedure is therefore carried out according to the following cycling operation with a total of 300 cycles (FIG. 3):
15 charging-discharging C/20 cycles (charging for 20 hours, discharging for 20 hours),
55 charging and discharging cycles at C/10,
50 charging-discharging cycles at C/5,
50 charging-discharging cycles at C/2,
50 cycles at C,
80 cycles at 2 C (charging within 30 minutes).

A second test procedure is carried out according to the following cycling with a total of 90 cycles (FIG. 4):
15 cycles at C/20,
15 cycles at C/10,
15 cycles at C/5,
15 cycles at C/2,
15 cycles at C,
15 cycles at 2 C.

In FIG. 2, all the curves have as an origin, 10 cycles at C/20; 10 cycles at C/10; 10 cycles at C/5; 10 cycles at C/2; 10 cycles at C except for “ORG” the curve of which is identical with that of FIG. 4 in terms of cycling.

For FIG. 5, 15 cycles at C/20 and then 55 cycles at C/10 are used.

The test temperature is 60° C.

The results of these tests and of the cycling operations are given in FIGS. 2 to 5.

FIG. 2 shows that the addition of an additive improves the performances of button battery cells according to the invention as compared with button cells non-compliant with the invention with ionic liquid electrolytes without any additive.

FIG. 3 shows an 80% capacity gain for a button battery cell according to the invention with a electrolyte comprising 5% of VEC by volume as compared with a button battery cell non-compliant with the invention with an electrolyte without any additives, and a 98% recovery (with 5% of VEC) of the practical capacity instead of 20% for the button cell with the electrolyte without any additive.

Further, this figure shows that 5% of additive is the optimum percentage.

FIG. 4 shows that button battery cells according to the invention with ionic liquid electrolytes with an additive are more performing than button battery cells with a standard organic electrolyte “ORG” at 60° C.

FIG. 5 shows that the button battery cells according to the invention with the electrolytes PP13TFSI+1.6 M LiTFSI and 5% by volume of VEC and HMITFSI+1.6 M LiTFSI and 5% by volume of VEC have better performances than the button battery cells with the organic electrolyte at 60° C. and provide a 15 to 30% gain in performance as compared with the performances of the organic electrolytes.

### REFERENCES

[1] M. HOLZAPFEL et al., Chem. Commun., 2004, 2098-2099
[2] T. SATO et al., Journal of Power Sources, 138 (2004) 253-261
[3] WO-A2-2005/117175
[4] Y. Hu et al., Electrochemistry Communications, 6 (2004), 126-131

1. A lithium ion rechargeable accumulator comprising:
a negative electrode, the active material of which comprises graphite carbon;
a positive electrode, the active material of which comprises LiFePO₄; and
an ionic liquid electrolyte comprising at least one ionic liquid of formula C⁺A, wherein C⁺ represents a cation and A represents an anion, and at least one conducting salt, the ionic liquid electrolyte further comprising an organic additive.

2. The lithium ion rechargeable accumulator according to claim 1, wherein the cation C⁺ of the ionic liquid is selected from organic cations.

3. The lithium ion rechargeable accumulator according to claim 1, wherein the cation C⁺ of the ionic liquid is selected from the group consisting of hydroxonium, oxonium, ammonium, amidinium, phosphonium, uronium, thiouronium, guanidinium, sulfonium, phospholium, phosphorolium, iodonium, carbonium cations; and heterocyclic cations, and the tautomeric forms thereof, and wherein the hetrocyclic cations are selected from the group consisting of pyridinium, quinolinium, isoquinolinium, imidazolium, pyrazolium, imidazolinium, triazolium, pyridazinium, pyrimidinium, pyrrolidinium, thiazolium, oxazolium, pyrazinium, piperazinium, piperidinium, pyrrolium, pyrizinium, indolium, quinoxalinium, thiomorpholinium, morpholinium, and indolinium cations; and the tautomeric forms thereof.

4. The lithium ion rechargeable accumulator according to claim 3, wherein the cation C⁺ of the ionic liquid is selected from non-substituted or substituted imidazoliums, and wherein the non-substituted or substituted imidazoliums are selected from the group consisting of di-, tri-, tetra- and penta-alkyl imidazoliums, quaternary ammoniums, non-substituted or substituted piperidiniums, non-substituted or substituted pyrrolidiniums, non-substituted or substituted pyrazoliums, non-substituted or substituted pyridiniums, phosphoniums, sulfoniums; and the tautomeric forms thereof.

5. The lithium ion rechargeable accumulator according to claim 3, wherein the C⁺ of the ionic liquid is selected from the group consisting of piperidiniums; quaternary ammoniums; imidazoliums, and penta-substituted immidazoliums; and the tautomeric forms thereof.

6. The lithium ion rechargeable accumulator according to claim 5, wherein the cation C⁺ of the ionic liquid is selected from the group consisting of N,N-propyl-methylpiperidinium, 1-hexyl-3-methylimidazolium, 1,2-dimethyl-3-n-butylimidazolium, and 1-n-butyl-3-methylimidazolium cations.

7. The lithium ion rechargeable accumulator according to claim 1, wherein the anion A⁻ of the ionic liquid is selected from halides, and wherein the halides are selected from the group consisting of Cl⁻, BF₄⁻, B(CN)₄⁻, CH₃BF₃⁻, CH₂CHBF₃⁻, CF₃BF₃⁻, m-CₙF₂ₙ₊₁BF₃⁻ wherein n is an integer such that 1≦n≦10, PF₆⁻, CF₃CO₂⁻, CF₃SO₃⁻, N(SO₂CF₃)₂⁻, N(COCF₃)(SOCF₃)⁻, N(CN)₂⁻, C(CN)₃⁻, SCN⁻, SeCN⁻, CuCl₂⁻, and AlCl₄⁻.

8. The lithium ion rechargeable accumulator according to claim 1, wherein the anion A⁻ of the ionic liquid is selected from the group consisting of BF₄⁻ and bis(trifluoromethanesulfonyl) imide TFSI (N(SO₂CF₃)₂⁻).

9. The lithium ion rechargeable accumulator according to claim 1 wherein the ionic liquid comprises a cation C⁺ selected from the group consisting of piperidiniums, quaternary ammoniums and imidazoliums, associated with an anion A⁻ selected from the group consisting of BF₄⁻ and bis(trifluoromethanesulfonyl)imidide TFSI (N(SO₂CF₃)₂⁻)).

10. The lithium ion rechargeable accumulator according to claim 9, wherein the ionic liquid is selected from the group consisting of PP₁₃TFSI, N,N-propyl-methyl-piperidinium bis(trifluoromethanesulfonyl)imidide; HMITFSI, (1-hexyl-3-methylimidazolium)bis(trifluoro-methanesulfonyl)imidide; DMBIFSI, (1,2-dimethyl-3-n-butylimidazolium)bis(trifluoromethanesulfonyl)imidide, BMITFSI, and (1-n-butyl-3-methyl-imidazolinium)bis(trifluoromethanesulfonyl)imidide, and mixtures thereof.

11. The lithium ion rechargeable accumulator according to claim 1, wherein the conducting salt is selected from lithium salts.

12. The lithium ion rechargeable accumulator according to claim 11, wherein the conducting salt is selected from the group consisting of LiPF₆: lithium hexafluorophosphate, LiBF₄: lithium tetrafluoroborate, LiAsF₆: lithium hexafluoroarsenate, LiClO₄: lithium perchlorate, LiBOB: lithium bis-oxalatoborate, LiFSI: lithium bis(fluorosulfonyl)imidide, salts of general formula Li[N(SO₂CₙF₂ₙ₊₁)(SO₂CₘF₂ₙ₊₁)]) wherein n and m, either identical or different, and wherein n and m are natural integers between 1 and 10, and mixtures thereof.

13. The lithium ion rechargeable accumulator according to claim 12, wherein the conducting salt is LiTFSI.

14. The lithium ion rechargeable accumulator according to claim 1 wherein the electrolyte comprises from about 0.1 to 10 mol/L of conducting salt.

15. The lithium ion rechargeable accumulator according to claim 1 wherein the electrolyte comprises from about 1 to 10% by volume, of additive, based on the volume of the ionic liquid.

16. The lithium ion rechargeable accumulator according to claim 1 wherein the electrolyte is composed of the ionic electrolyte(s), the conducting salt(s), and the additive.

17. The lithium ion rechargeable accumulator according to claim 1, wherein the electrolyte comprises LiTFSI in an ionic liquid solvent selected from the group consisting of PP₁₃TFSI, HMITFSI, DMBITFSI, and BMITFSI; and from about 1 to 10% by volume of vinyl ethylene carbonate VEC., preferably 5% by volume of VEC.

18. The accumulator according to claim 17, wherein the electrolyte comprises 1.6 mol/L of LiTFSI.

19. The lithium ion rechargeable accumulator according to claim 1, wherein the rechargeable accumulator comprises a button battery cell.

20. An ionic liquid electrolyte comprising LiTFSI in an ionic liquid solvent selected from the group consisting of PP₁₃TFSI, HMITFSI, DMBITFSI, and BMITFSI; and from about 1 to 10% by volume of vinyl ethylene carbonate (VEC).

21. The ionic liquid electrolyte according to claim 20, comprising 1.6 mol/L of LiTFSI.

22. The lithium ion rechargeable accumulator according to claim 4, wherein the cation C+ of the ionic liquid is selected from the group consisting of dialkylpiperidiniums, dialkylpyrrolidiniums, dialkylpyrazoliums, alkylpyridinium, tetraalkylphosphoniums, trialkylsulfoniums, and the tautomeric forms thereof.

23. The lithium ion rechargeable accumulator according to claim 5, wherein the C⁺ of the ionic liquid is selected from the group consisting dialkylpiperidiniums; quaternary ammoniums bearing four alkyl groups; di-, tri-, and tetra-, and penta-substituted immidazoliums such as di-, tri-, tetra- and penta-alkylimidazoliums; and the tautomeric forms thereof.

24. The lithium ion rechargeable accumulator according to claim 12, wherein the conducting salt is selected from the group consisting of LiTFSI: lithium bis(trifluoromethylsulfonyl)imidide or LiN(CF₃SO₂)₂, LiBeti: lithium bis(perfluoroethylsulfonyl)imidide, LiODBF, LiB(C₆H₅), LiCF₃SO₃, and LiC(CF₃SO₂)₃ (LiTFSM), and mixtures thereof.

25. The lithium ion rechargeable accumulator according to claim 15, wherein the electrolyte comprises from about 2 to 5% by volume, of additive; based on the volume of the ionic liquid.

26. The lithium ion rechargeable accumulator according to claim 17, wherein the electrolyte comprises about 5% by volume of VEC.

27. The lithium ion rechargeable accumulator according to claim 1, wherein the organic additive is vinyl ethylene carbonate (VEC) and mixtures thereof.
